(19) United States
(12) Patent Application Publication
(10) Pub. No.: US 2015/0063151 A1
(43) Pub. Date: Mar. 5, 2015

(54) OPPORTUNISTIC SUPPLEMENTAL DOWNLINK IN UNLICENSED SPECTRUM

(71) Applicant: QUALCOMM Incorporated, San Diego, CA (US)

(72) Inventors: Ahmed Kamel SADEK, San Diego, CA (US); Yeliz TOKGOZ, San Diego, CA (US); Mehmet YAVUZ, San Diego, CA (US); Tamer Adel KADOUS, San Diego, CA (US); Mingxi FAN, San Diego, CA (US); Akula Aneesh REDDY, San Diego, CA (US)

(21) Appl. No.: 14/476,150

(22) Filed: Sep. 3, 2014

Related U.S. Application Data
(60) Provisional application No. 61/873,587, filed on Sep. 4, 2013.
(60) Provisional application No. 62/013,391, filed on Jun. 17, 2014.

(51) Int. Cl. H04W 72/04; H04W 24/08

(52) U.S. Cl. CPC H04W 72/0406; H04W 24/08
USPC 370/252; 370/329

(57) ABSTRACT

Systems and methods for managing communication in an unlicensed band of frequencies to supplement communication in a licensed band of frequencies in unlicensed spectrum are disclosed. The management may comprise, for example, monitoring utilization of resources currently available to a first Radio Access Technology (RAT) via at least one of a Primary Cell (PCell) operating in the licensed band, a set of one or more Secondary Cells (SCells) operating in the unlicensed band, or a combination thereof. Based on the utilization, a first SCell among the set of SCells may be configured or de-configured with respect to operation in the unlicensed band.

### CROSS-REFERENCE TO RELATED APPLICATIONS

The present application for patent claims the benefit of U.S. Provisional Application No. 61/873,587, entitled “UNLICENSED WIRELESS CARRIER MANAGEMENT,” filed Sep. 4, 2013, and U.S. Provisional Application No. 62/013,391, entitled “OPPORTUNISTIC SUPPLEMENTAL DOWNLINK IN UNLICENSED SPECTRUM,” filed Jun. 17, 2014, both assigned to the assignee hereof, and expressly incorporated herein by reference in their entirety.

### REFERENCE TO CO-PENDING APPLICATIONS FOR PATENT

The present application for patent is also related to the following co-pending U.S. patent application: “MEASUREMENT REPORTING IN UNLICENSED SPECTRUM,” having Attorney Docket No. QC134598U1, filed concurrently herewith, assigned to the assignee hereof, and expressly incorporated herein by reference in its entirety.

### INTRODUCTION

Aspects of this disclosure relate generally to telecommunications, and more particularly to co-existence interference management and the like.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Third Generation Partnership Project (3GPP), 3GPP Long Term Evolution (LTE), Ultra Mobile Broadband (UMB), Evolution Data Optimized (EV-DO), Institute of Electrical and Electronics Engineers (IEEE), etc.

In cellular networks, “macro cell” base stations provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience.

To improve indoor or other specific geographic coverage, such as for residential homes and office buildings, additional “small cell,” typically low-power base stations have recently begun to be deployed to supplement conventional macro networks. Small cell base stations may also provide incremental capacity growth, richer user experience, and so on.

Recently, small cell LTE operations, for example, have been extended into the unlicensed frequency spectrum such as the Unlicensed National Information Infrastructure (U-NII) band used by Wireless Local Area Network (WLAN) technologies. This extension of small cell LTE operation is designed to increase spectral efficiency and hence capacity of the LTE system. However, it may also encroach on the operations of other Radio Access Technologies (RATs) that typically utilize the same unlicensed bands, most notably IEEE 802.11x WLAN technologies generally referred to as “Wi-Fi.”

Different approaches to interference management for such a co-existence environment have been proposed. There remains a need, however, for improved operation to better manage interference to various devices operating in the increasingly crowded unlicensed frequency spectrum.

### SUMMARY

Systems and methods for managing communication in an unlicensed band of frequencies to supplement communication in a licensed band of frequencies are disclosed.

A method is disclosed for managing communication in an unlicensed band of radio frequencies to supplement communication in a licensed band of radio frequencies. The method may comprise, for example: monitoring utilization of resources currently available to a first Radio Access Technology (RAT) via at least one of a Primary Cell (PCell) operating in the licensed band, a set of one or more Secondary Cells (SCells) operating in the unlicensed band, or a combination thereof; and configuring or de-configuring a first SCell among the set of SCells with respect to operation in the unlicensed band based on the utilization.

An apparatus is also disclosed for managing communication in an unlicensed band of radio frequencies to supplement communication in a licensed band of radio frequencies. The apparatus may comprise, for example, a processor and memory coupled to the processor for storing related data and instructions. The processor may be configured to, for example: monitor utilization of resources currently available to a first RAT via at least one of a PCell operating in the licensed band, a set of one or more SCells operating in the unlicensed band, or a combination thereof; and configure or de-configuring a first SCell among the set of SCells with respect to operation in the unlicensed band based on the utilization.

Another apparatus is also disclosed for managing communication in an unlicensed band of radio frequencies to supplement communication in a licensed band of radio frequencies. The apparatus may comprise, for example: means for monitoring utilization of resources currently available to a first RAT via at least one of a PCell operating in the licensed band, a set of one or more SCells operating in the unlicensed band, or a combination thereof; and means for configuring or de-configuring a first SCell among the set of SCells with respect to operation in the unlicensed band based on the utilization.

A computer-readable medium is also disclosed that comprises instructions, which, when executed by a processor, cause the processor to perform operations for managing communication in an unlicensed band of radio frequencies to supplement communication in a licensed band of radio frequencies. The computer-readable medium may comprise, for example: instructions for monitoring utilization of resources currently available to a first RAT via at least one of a PCell operating in the licensed band, a set of one or more SCells operating in the unlicensed band, or a combination thereof; and instructions for configuring or de-configuring a first SCell among the set of SCells with respect to operation in the unlicensed band based on the utilization.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example mixed-deployment wireless communication system including macro cell base stations and small cell base stations.

FIG. 2 is a block diagram illustrating an example downlink frame structure for LTE communications.

FIG. 3 is a block diagram illustrating an example uplink frame structure for LTE communications.

FIG. 4 illustrates an example small cell base station with co-located radio components (e.g., LTE and Wi-Fi) configured for unlicensed spectrum operation.

FIG. 5 is a signaling flow diagram illustrating an example message exchange between co-located radios.

FIG. 6 is a system-level co-existence state diagram illustrating different aspects of cellular operation that may be specially adapted to manage co-existence between different RATs operating on a shared unlicensed band.

FIG. 7 illustrates in more detail certain aspects a Carrier Sense Adaptive Transmission (CSAT) communication scheme for cycling cellular operation in accordance with a long-term Time Division Multiplexed (TDM) communication pattern.

FIG. 8 is a state diagram illustrating Opportunistic Supplemental DownLink (OSDL) management of Secondary Cells (SCells) operating in conjunction with a given Primary Cell (PCell) to provide SDL coverage.

FIG. 9 is a flow diagram illustrating an example method of managing communication in an unlicensed band of frequencies to supplement communication in a licensed band of frequencies.

FIG. 10 is a simplified block diagram of several sample aspects of components that may be employed in communication nodes and configured to support communication as taught herein.

FIG. 11 is another simplified block diagram of several sample aspects of apparatuses configured to support communication as taught herein.

FIG. 12 illustrates an example communication system environment in which the teachings and structures herein may be may be incorporated.

### DETAILED DESCRIPTION

The present disclosure relates generally to dynamic or “opportunistic” Supplemental DownLink (SDL) in unlicensed spectrum for managing communication in an unlicensed band of frequencies to supplement communication in a licensed band of frequencies. SDL communication may be used in this manner to opportunistically expand system capacity via operation in the unlicensed spectrum when and only when needed, such as when user devices that have the capability to operate in unlicensed spectrum are within the corresponding coverage region and have traffic that can be sent on the SDL. This helps to mitigate unnecessary interference to other small cells and other Radio Access Technologies (RATs). For example, it may help Wi-Fi transmissions and thereby make cellular technologies such as Long Term Evolution (LTE) better neighbors to Wi-Fi. It may also reduce pilot contamination. It may also improve Secondary Cell (SCell) coverage for small cell base stations configured with multiple SCells.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

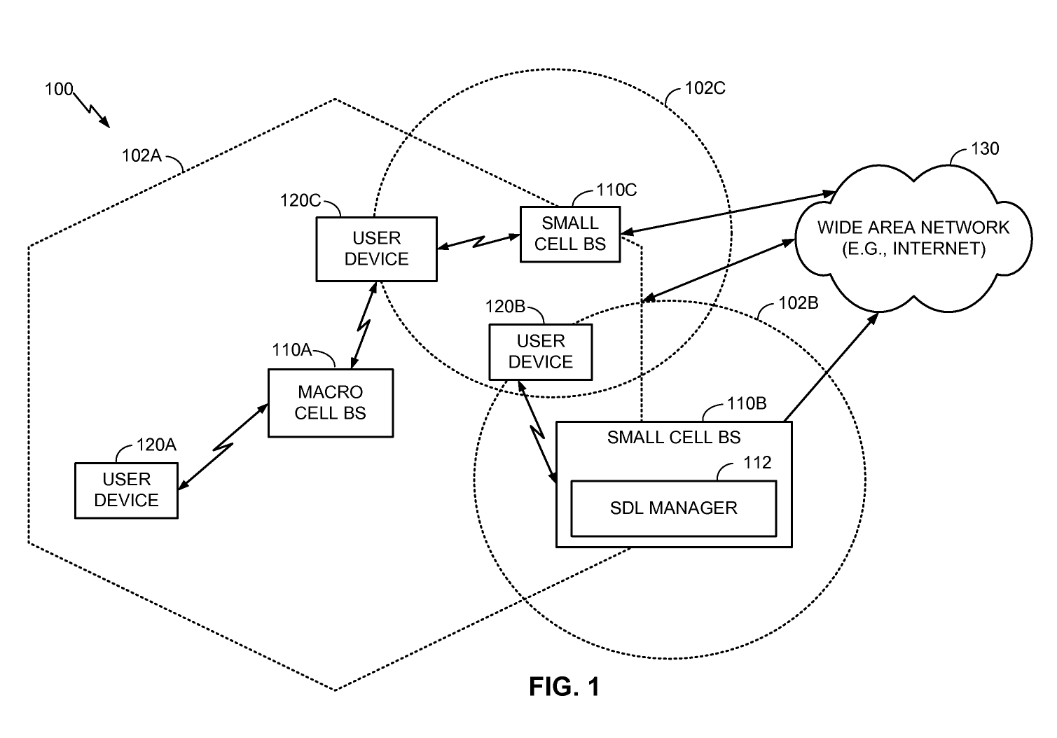

FIG. 1 illustrates an example mixed-deployment wireless communication system, in which small cell base stations are deployed in conjunction with and to supplement the coverage of macro cell base stations. As used herein, small cells generally refer to a class of low-powered base stations that may include or be otherwise referred to as femto cells, pico cells, micro cells, etc. As noted in the background above, they may be deployed to provide improved signaling, incremental capacity growth, richer user experience, and so on.

The illustrated wireless communication system 100 is a multiple-access system that is divided into a plurality of cells 102 and configured to support communication for a number of users. Communication coverage in each of the cells 102 is provided by a corresponding base station 110, which interacts with one or more user devices 120 via DownLink (DL) and/or UpLink (UL) connections. In general, the DL corresponds to communication from a base station to a user device, while the UL corresponds to communication from a user device to a base station.

As will be described in more detail below, these different entities may be variously configured in accordance with the teachings herein to provide or otherwise support the SDL management discussed briefly above. For example, one or more of the small cell base stations 110 may include an SDL management module 112.

As used herein, the terms “user device” and “base station” are not intended to be specific or otherwise limited to any particular Radio Access Technology (RAT), unless otherwise noted. In general, such user devices may be any wireless communication device (e.g., a mobile phone, router, personal computer, server, etc.) used by a user to communicate over a communications network, and may be alternatively referred to in different RAT environments as an Access Terminal (AT), a Mobile Station (MS), a Subscriber Station (STA), a User Equipment (UE), etc. Similarly, a base station may operate according to one of several RATs in communication with user devices depending on the network in which it is deployed, and may be alternatively referred to as an Access Point (AP), a Network Node, a NodeB, an evolved NodeB (eNB), etc. In addition, in some systems a base station may provide purely edge node signaling functions while in other systems it may provide additional control and/or network management functions.

Returning to FIG. 1, the different base stations 110 include an example macro cell base station 110A and two example small cell base stations 110B, 110C. The macro cell base station 110A is configured to provide communication coverage within a macro cell coverage area 102A, which may cover a few blocks within a neighborhood or several square miles in a rural environment. Meanwhile, the small cell base stations 110B, 110C are configured to provide communication coverage within respective small cell coverage areas 102B, 102C, with varying degrees of overlap existing among the different coverage areas. In some systems, each cell may be further divided into one or more sectors (not shown).

Turning to the illustrated connections in more detail, the user device 120A may transmit and receive messages via a wireless link with the macro cell base station 110A, the message including information related to various types of communication (e.g., voice, data, multimedia services, associated control signaling, etc.). The user device 120B may similarly communicate with the small cell base station 110B via another wireless link, and the user device 120C may similarly communicate with the small cell base station 110C via another wireless link. In addition, in some scenarios, the user device 120C, for example, may also communicate with the macro cell base station 110A via a separate wireless link in addition to the wireless link it maintains with the small cell base station 110C.

As is further illustrated in FIG. 1, the macro cell base station 110A may communicate with a corresponding wide area or external network 130, via a wired link or via a wireless link, while the small cell base stations 110B, 110C may also similarly communicate with the network 130, via their own wired or wireless links. For example, the small cell base stations 110B, 110C may communicate with the network 130 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The network 130 may comprise any type of electronically connected group of computers and/or devices, including, for example, Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 130 includes network variations such as the public Internet, a private network within the Internet, a secure network within the Internet, a private network, a public network, a value-added network, an intranet, and the like. In certain systems, the network 130 may also comprise a Virtual Private Network (VPN).

Accordingly, it will be appreciated that the macro cell base station 110A and/or either or both of the small cell base stations 110B, 110C may be connected to the network 130 using any of a multitude of devices or methods. These connections may be referred to as the “backbone” or the “backhaul” of the network, and may in some implementations be used to manage and coordinate communications between the macro cell base station 110A, the small cell base station 110B, and/or the small cell base station 110C. In this way, as a user device moves through such a mixed communication network environment that provides both macro cell and small cell coverage, the user device may be served in certain locations by macro cell base stations, at other locations by small cell base stations, and, in some scenarios, by both macro cell and small cell base stations.

For their wireless air interfaces, each base station 110 may operate according to one of several RATs depending on the network in which it is deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2). These documents are publicly available.

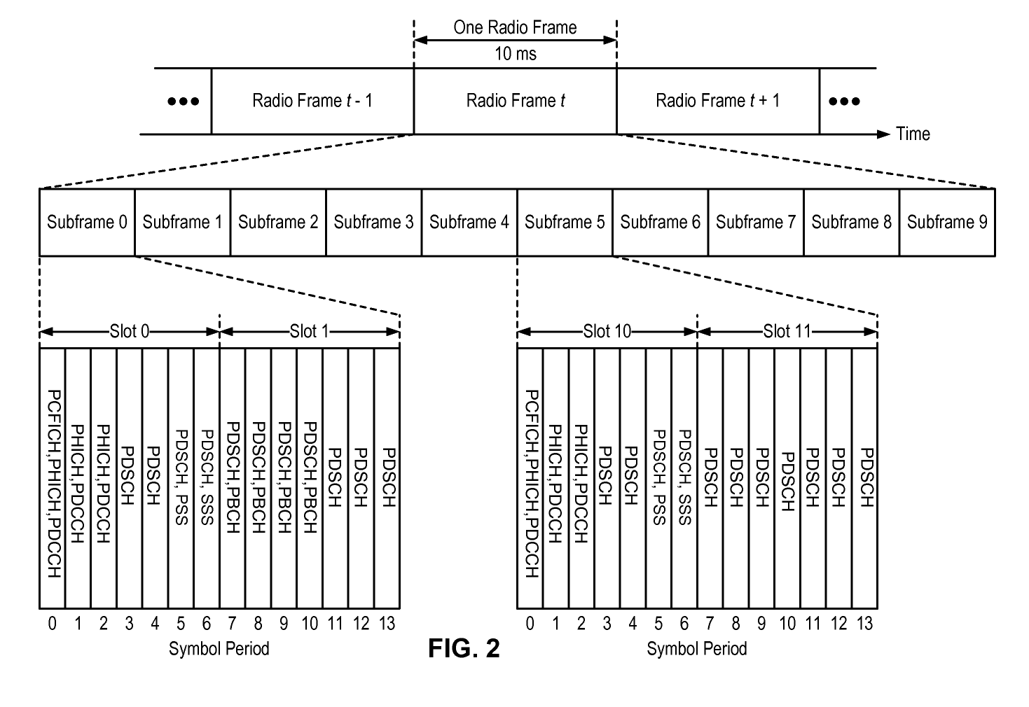

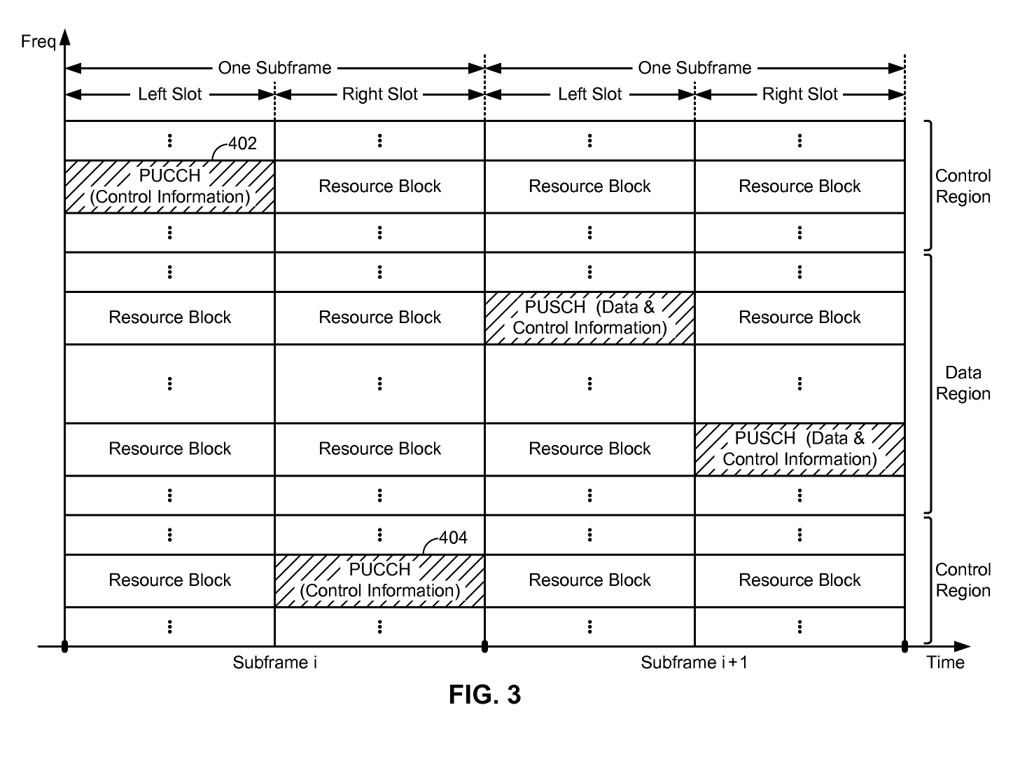

For illustration purposes, an example downlink and uplink frame structure for an LTE signaling scheme is described below with reference to FIGS. 2-3.

FIG. 2 is a block diagram illustrating an example downlink frame structure for LTE communications. In LTE, the base stations 110 of FIG. 1 are generally referred to as eNBs and the user devices 120 are generally referred to as UEs. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a Primary Synchronization Signal (PSS) and a Secondary Synchronization Signal (SSS) for each cell in the eNB. The PSS and SSS may be sent in symbol periods 5 and 6, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

Reference signals are transmitted during the first and fifth symbol periods of each slot when the normal cyclic prefix is used and during the first and fourth symbol periods when the extended cyclic prefix is used. For example, the eNB may send a Cell-specific Reference Signal (CRS) for each cell in the eNB on all component carriers. The CRS may be sent in symbols 0 and 4 of each slot in case of the normal cyclic prefix, and in symbols 0 and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may send a Physical Control Format Indicator Channel (PCFICH) in the first symbol period of each subframe, as seen in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support Hybrid Automatic Repeat Request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into Resource Element Groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 3 is a block diagram illustrating an example uplink frame structure for LTE communications. The available resource blocks (which may be referred to as RBs) for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 3.

Returning to FIG. 1, cellular systems such as LTE are typically confined to one or more licensed frequency bands that have been reserved for such communications (e.g., by a government entity such as the Federal Communications Commission (FCC) in the United States). However, certain communication systems, in particular those employing small cell base stations as in the design of FIG. 1, have extended cellular operations into unlicensed frequency bands such as the Unlicensed National Information Infrastructure (U-NII) band used by Wireless Local Area Network (WLAN) technologies. For illustration purposes, the description below may refer in some respects to an LTE system operating on an unlicensed band by way of example when appropriate, although it will be appreciated that such descriptions are not intended to exclude other cellular communication technologies. LTE on an unlicensed band may also be referred to herein as LTE/LTE-Advanced in unlicensed spectrum, or simply LTE in the surrounding context. With reference to FIGS. 2-3 above, the PSS, SSS, CRS, PBCH, PUCCH, and PUSCH in LTE on an unlicensed band are otherwise the same or substantially the same as in the LTE standard described in 3GPP TS 36.211, entitled “Evolved Universal Terrestrial Radio Access (E-UTRA); Physical Channels and Modulation,” which is publicly available.

The unlicensed spectrum may be employed by cellular systems in different ways. For example, in some systems, the unlicensed spectrum may be employed in a standalone configuration, with all carriers operating exclusively in an unlicensed portion of the wireless spectrum (e.g., LTE Standalone). In other systems, the unlicensed spectrum may be employed in a manner that is supplemental to licensed band operation by utilizing one or more unlicensed carriers operating in the unlicensed portion of the wireless spectrum in conjunction with an anchor licensed carrier operating in the licensed portion of the wireless spectrum (e.g., LTE Supplemental DownLink (SDL)). In either case, carrier aggregation may be employed to manage the different component carriers, with one carrier serving as the Primary Cell (PCell) for the corresponding user (e.g., an anchor licensed carrier in LTE SDL or a designated one of the unlicensed carriers in LTE Standalone) and the remaining carriers serving as respective Secondary Cells (SCells). In this way, the PCell may provide a Frequency Division Duplexed (FDD) pair of downlink and uplink carriers (licensed or unlicensed), with each SCell providing additional downlink capacity as desired.

The extension of small cell operation into unlicensed frequency bands such as the U-NII (5 GHz) band may therefore be implemented in a variety of ways and increase the capacity of cellular systems such as LTE. As discussed briefly in the background above, however, it may also encroach on the operations of other “native” RATs that typically utilize the same unlicensed band, most notably IEEE 802.11x WLAN technologies generally referred to as “Wi-Fi.”

In some small cell base station designs, the small cell base station may include such a native RAT radio co-located with its cellular radio. According to various aspects described herein, the small cell base station may leverage the co-located radio to facilitate co-existence between the different RATs when operating on a shared unlicensed band. For example, the co-located radio may be used to conduct different measurements on the unlicensed band and dynamically determine the extent to which the unlicensed band is being utilized by devices operating in accordance with the native RAT. The cellular radio's use of the shared unlicensed band may then be specially adapted to balance the desire for efficient cellular operation against the need for stable co-existence.

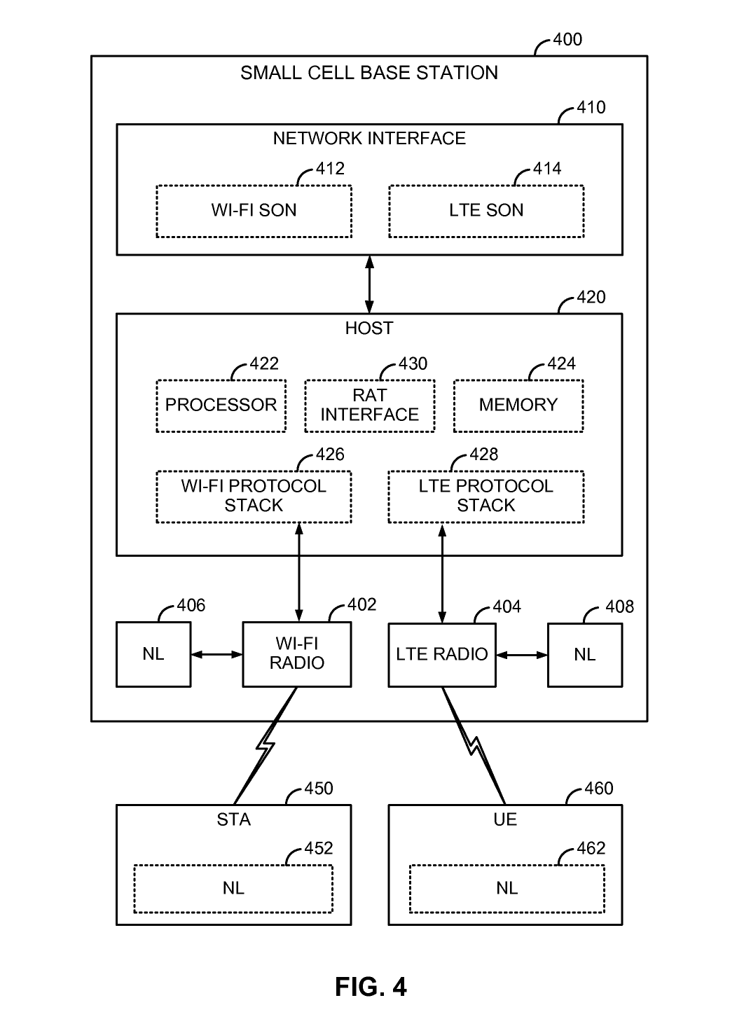

FIG. 4 illustrates an example small cell base station with co-located radio components configured for unlicensed spectrum operation. The small cell base station 400 may correspond, for example, to one of the small cell base stations 110B, 110C illustrated in FIG. 1. In this example, the small cell base station 400 is configured to provide a WLAN air interface (e.g., in accordance with an IEEE 802.11x protocol) in addition to a cellular air interface (e.g., in accordance with an LTE protocol). For illustration purposes, the small cell base station 400 is shown as including an 802.11x radio component/module (e.g., transceiver) 402 co-located with an LTE radio component/module (e.g., transceiver) 404.

As used herein, the term co-located (e.g., radios, base stations, transceivers, etc.) may include in accordance with various aspects, one or more of, for example: components that are in the same housing; components that are hosted by the same processor; components that are within a defined distance of one another; and/or components that are connected via an interface (e.g., an Ethernet switch) where the interface meets the latency requirements of any required inter-component communication (e.g., messaging). In some designs, the advantages discussed herein may be achieved by adding a radio component of the native unlicensed band RAT of interest to a given cellular small cell base station without that base station necessarily providing corresponding communication access via the native unlicensed band RAT (e.g., adding a Wi-Fi chip or similar circuitry to an LTE small cell base station). If desired, a low functionality Wi-Fi circuit may be employed to reduce costs (e.g., a Wi-Fi receiver simply providing low-level sniffing).

Returning to FIG. 4, the Wi-Fi radio 402 and the LTE radio 404 may perform monitoring of one or more channels (e.g., on a corresponding carrier frequency) to perform various corresponding operating channel or environment measurements (e.g., CQI, RSSI, RSRP, or other RLM measurements) using corresponding Network/Neighbor Listen (NL) modules 406 and 408, respectively, or any other suitable component(s).

The small cell base station 400 may communicate with one or more user devices via the Wi-Fi radio 402 and the LTE radio 404, illustrated as an STA 450 and a UE 460, respectively. Similar to the Wi-Fi radio 402 and the LTE radio 404, the STA 450 includes a corresponding NL module 452 and the UE 460 includes a corresponding NL module 462 for performing various operating channel or environment measurements, either independently or under the direction of the Wi-Fi radio 402 and the LTE radio 404, respectively. In this regard, the measurements may be retained at the STA 450 and/or the UE 460, or reported to the Wi-Fi radio 402 and the LTE radio 404, respectively, with or without any pre-processing being performed by the STA 450 or the UE 460.

While FIG. 4 shows a single STA 450 and a single UE 460 for illustration purposes, it will be appreciated that the small cell base station 400 can communicate with multiple STAs and/or UEs. Additionally, while FIG. 4 illustrates one type of user device communicating with the small cell base station 400 via the Wi-Fi radio 402 (i.e., the STA 450) and another type of user device communicating with the small cell base station 400 via the LTE radio 404 (i.e., the UE 460), it will be appreciated that a single user device (e.g., a smartphone) may be capable of communicating with the small cell base station 400 via both the Wi-Fi radio 402 and the LTE radio 404, either simultaneously or at different times.

As is further illustrated in FIG. 4, the small cell base station 400 may also include a network interface 410, which may include various components for interfacing with corresponding network entities (e.g., Self-Organizing Network (SON) nodes), such as a component for interfacing with a Wi-Fi SON 412 and/or a component for interfacing with an LTE SON 414. The small cell base station 400 may also include a host 420, which may include one or more general purpose controllers or processors 422 and memory 424 configured to store related data and/or instructions. The host 420 may perform processing in accordance with the appropriate RAT(s) used for communication (e.g., via a Wi-Fi protocol stack 426 and/or an LTE protocol stack 428), as well as other functions for the small cell base station 400. In particular, the host 420 may further include a RAT interface 430 (e.g., a bus or the like) that enables the radios 402 and 404 to communicate with one another via various message exchanges.

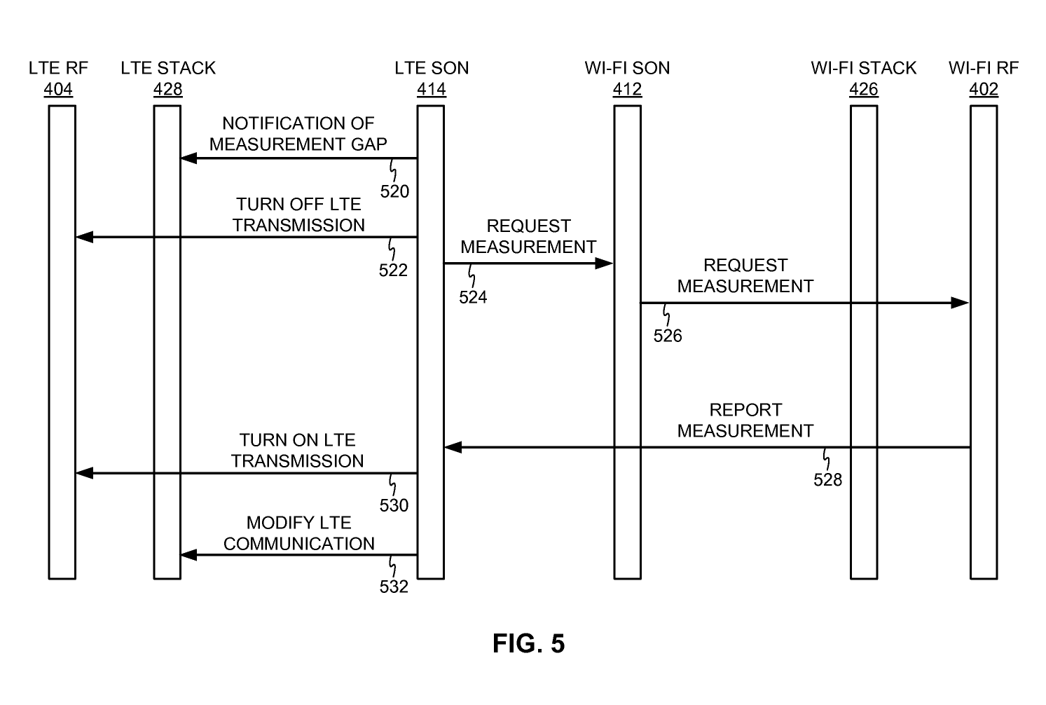

FIG. 5 is a signaling flow diagram illustrating an example message exchange between co-located radios. In this example, one RAT (e.g., LTE) requests a measurement from another RAT (e.g., Wi-Fi) and opportunistically ceases transmission for the measurement. FIG. 5 will be explained below with continued reference to FIG. 4.

Initially, the LTE SON 414 notifies the LTE stack 428 via a message 520 that a measurement gap is upcoming on the shared unlicensed band. The LTE SON 414 then sends a command 522 to cause the LTE radio (RF) 404 to temporarily turn off transmission on the unlicensed band, in response to which the LTE radio 404 disables the appropriate RF components for a period of time (e.g., so as to not interfere with any measurements during this time).

The LTE SON 414 also sends a message 524 to the co-located Wi-Fi SON 412 requesting that a measurement be taken on the unlicensed band. In response, the Wi-Fi SON 412 sends a corresponding request 526 via the Wi-Fi stack 426 to the Wi-Fi radio 402, or some other suitable Wi-Fi radio component (e.g., a low cost, reduced functionality Wi-Fi receiver).

After the Wi-Fi radio 402 conducts measurements for Wi-Fi related signaling on the unlicensed band, a report 528 including the results of the measurements is sent to the LTE SON 414 via the Wi-Fi stack 426 and the Wi-Fi SON 412. In some instances, the measurement report may include not only measurements performed by the Wi-Fi radio 402 itself, but also measurements collected by the Wi-Fi radio 402 from the STA 450. The LTE SON 414 may then send a command 530 to cause the LTE radio 402 to turn back on transmission on the unlicensed band (e.g., at the end of the defined period of time).

The information included in the measurement report (e.g., information indicative of how Wi-Fi devices are utilizing the unlicensed band) may be compiled along with various LTE measurements and measurement reports. Based on information about the current operating conditions on the shared unlicensed band (e.g., as collected by one or a combination of the Wi-Fi radio 402, the LTE radio 404, the STA 450, and/or the UE 460), the small cell base station 400 may specially adapt different aspects of its cellular operations in order to manage co-existence between the different RATs. Returning to FIG. 5, the LTE SON 414, for example, may then send a message 532 that informs the LTE stack 428 how LTE communication is to be modified.

There are several aspects of cellular operation that may be adapted in order to manage co-existence between the different RATs. For example, the small cell base station 400 may select certain carriers as preferable when operating in the unlicensed band, may opportunistically enable or disable operation on those carriers, may selectively adjust the transmission power of those carriers, if necessary (e.g., periodically or intermittently in accordance with a transmission pattern), and/or take other steps to balance the desire for efficient cellular operation against the need for stable co-existence.

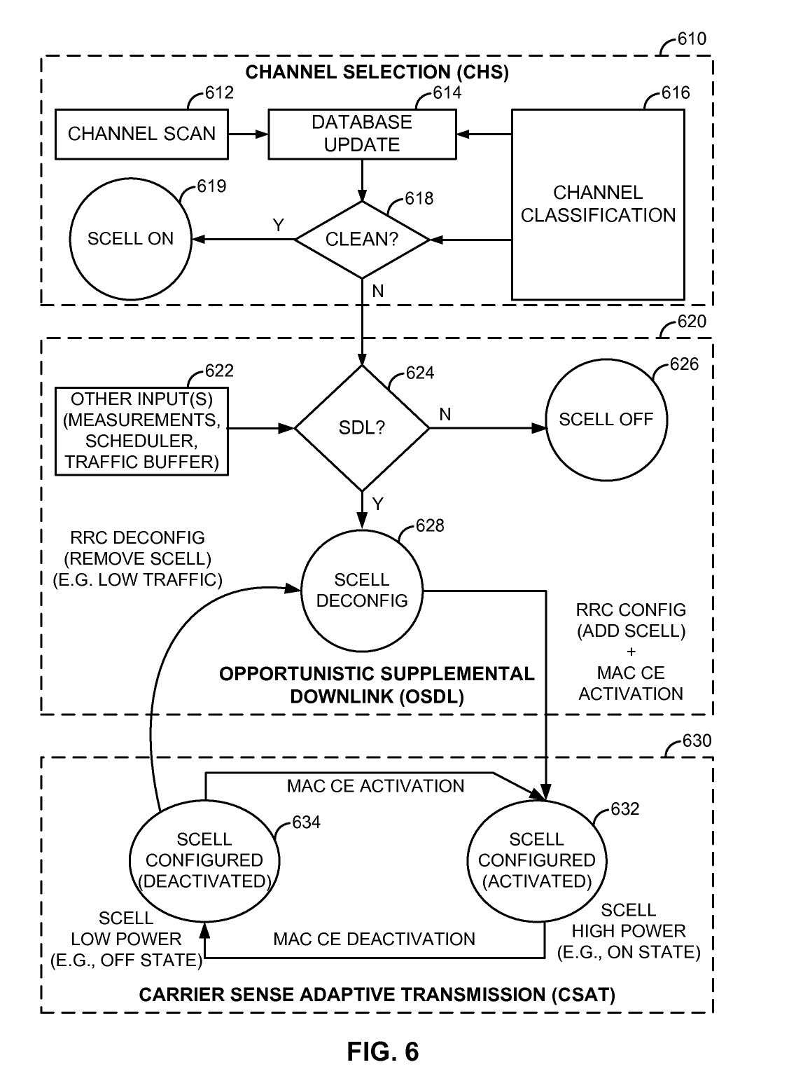

FIG. 6 is a system-level co-existence state diagram illustrating different aspects of cellular operation that may be specially adapted to manage co-existence between different RATs operating on a shared unlicensed band. As shown, the techniques in this example include operations that will be referred to herein as Channel Selection (CHS) where appropriate unlicensed carriers are analyzed, Opportunistic Supplemental Downlink (OSDL) where operation on one or more corresponding SCells is configured or deconfigured, and Carrier Sense Adaptive Transmission (CSAT) where the transmission power on those SCells is adapted, if necessary, by cycling between periods of high transmission power (e.g., an ON state, as a special case) and low transmission power (e.g., an OFF state, as a special case).

For CHS (block 610), a channel selection algorithm may perform certain periodic or event-driven scanning procedures (e.g., initial or threshold triggered) (block 612). With reference to FIG. 4, the scanning procedures may utilize, for example, one or a combination of the Wi-Fi radio 402, the LTE radio 404, the STA 420, and/or the UE 430. The scan results may be stored (e.g., over a sliding time window) in a corresponding database (block 614) and used to classify the different channels in terms of their potential for cellular operation (block 616). For example, a given channel may be classified, at least in part, based on whether it is a clean channel or whether it will need to be afforded some level of protection for co-channel communications. Various cost functions and associated metrics may be employed in the classification and related calculations.

If a clean channel is identified (‘yes’ at decision 618), a corresponding SCell may be operated without concern for impacting co-channel communications (state 619). On the other hand, if no clean channel is identified, further processing may be utilized to reduce the impact on co-channel communications (‘no’ at decision 618), as described below.

Turning to OSDL (block 620), input may be received from the channel selection algorithm as well as from other sources, such as various measurements, schedulers, traffic buffers, etc. (block 622), to determine whether unlicensed operation is warranted without a clean channel being available (decision 624). For example, if there is not enough traffic to support a secondary carrier in the unlicensed band (‘no’ at decision 624), the corresponding SCell that supports it may be disabled (state 626). Conversely, if there is a substantial amount of traffic (‘yes’ at decision 624), even though a clean channel is not available, an SCell may nevertheless be constructed from one or more of the remaining carriers by invoking CSAT operation (block 630) to mitigate the potential impact on co-existence.

Returning to FIG. 6, the SCell may be initially enabled in a deconfigured state (state 628). The SCell along with one or more corresponding user devices may then be configured and activated (state 630) for normal operation. In LTE, for example, an associated UE may be configured and deconfigured via corresponding RRC Config/Deconfig messages to add the SCell to its active set. Activation and deactivation of the associated UE may be performed, for example, by using Medium Access Control (MAC) Control Element (CE) Activation/Deactivation commands. At a later time, when the traffic level drops below a threshold, for example, an RRC Deconfig message may be used to remove the SCell from the UE's active set, and return the system to the deconfigured state (state 628). If all UEs are deconfigured, OSDL may be invoked to turn the SCell off.

During CSAT operation (block 630), the SCell may remain configured but be cycled between periods of activated operation (state 632) and periods of deactivated operation (state 634) in accordance with a (long-term) Time Division Multiplexed (TDM) communication pattern. In the configured/activated state (state 632), the SCell may operate at relatively high power (e.g., full powered ON state). In the configured/deactivated state (state 634), the SCell may operate at a reduced, relatively low power (e.g., depowered OFF state).

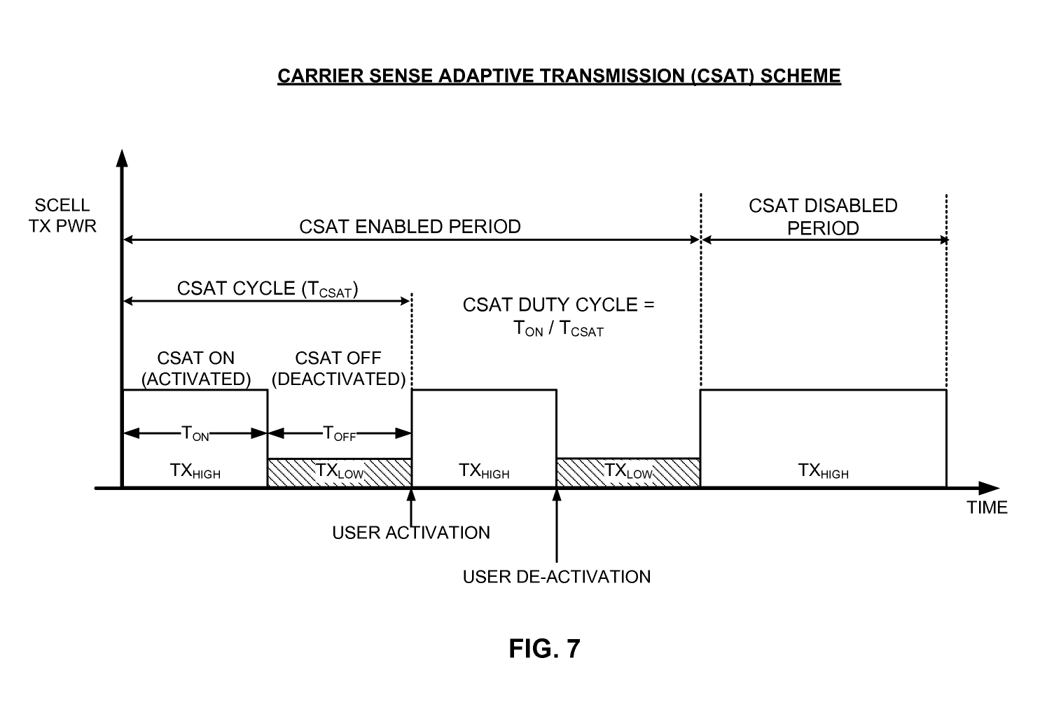

FIG. 7 illustrates in more detail certain aspects a CSAT communication scheme for cycling cellular operation in accordance with a long-term TDM communication pattern. As discussed above in relation to FIG. 6, CSAT may be selectively enabled on one or more SCells as appropriate to facilitate co-existence in unlicensed spectrum, even when a clean channel free of competing RAT operation is not available.

When enabled, SCell operation is cycled between CSAT ON (activated) periods and CSAT OFF (deactivated) periods within a given CSAT cycle (T_{CSAT}). One or more associated user devices may be similarly cycled between corresponding MAC activated and MAC deactivated periods. During an associated activated period of time T_{ON}, SCell transmission on the unlicensed band may proceed at a normal, relatively high transmission power. During an associated deactivated period of time T_{OFF}, however, the SCell remains in a configured state but transmission on the unlicensed band is reduced or even fully disabled to yield the medium to a competing RAT (as well as to perform various measurements via a co-located radio of the competing RAT).

Each of the associated CSAT parameters, including, for example, the CSAT pattern duty cycle (i.e., T_{ON}/T_{CSAT}) and the relative transmission powers during activated/deactivated periods, may be adapted based on the current signaling conditions to optimize CSAT operation. As an example, if the utilization of a given channel by Wi-Fi devices is high, an LTE radio may adjust one or more of the CSAT parameters such that usage of the channel by the LTE radio is reduced. For example, the LTE radio may reduce its transmit duty cycle or transmit power on the channel. Conversely, if utilization of a given channel by Wi-Fi devices is low, an LTE radio may adjust one or more of the CSAT parameters such that usage of the channel by the LTE radio is increased. For example, the LTE radio may increase its transmit duty cycle or transmit power on the channel. In either case, the CSAT ON (activated) periods may be made sufficiently long (e.g., greater than or equal to about 200 msec) to provide user devices with a sufficient opportunity to perform at least one measurement during each CSAT ON (activated) period.

A CSAT scheme as provided herein may offer several advantages for mixed RAT co-existence, particular in unlicensed spectrum. For example, by adapting communication based on signals associated with a first RAT (e.g., Wi-Fi), a second RAT (e.g., LTE) may react to utilization of a co-channel by devices that use the first RAT while refraining from reacting to extraneous interference by other devices (e.g., non-Wi-Fi devices) or adjacent channels. As another example, a CSAT scheme enables a device that uses one RAT to control how much protection is to be afforded to co-channel communications by devices that use another RAT by adjusting the particular parameters employed. In addition, such a scheme may be generally implemented without changes to the underlying RAT communication protocol. In an LTE system, for example, CSAT may be generally implemented without changing the LTE PHY or MAC layer protocols, but by simply changing the LTE software.

To improve overall system efficiency, the CSAT cycle may be synchronized, in whole or in part, across different small cells, at least within a given operator. For example, the operator may set a minimum CSAT ON (activated) period (T_{ON,min}) and a minimum CSAT OFF (deactivated) period (T_{OFF,min}). Accordingly, the CSAT ON (activated) period durations and transmission powers may be different, but minimum deactivation times and certain channel selection measurement gaps may be synchronized.

As a further enhancement, the OSDL algorithm may be configured to more intelligently manage SDL operation based on factors such as current and estimated resource utilization, spectrum efficiency, coverage regions, user device proximity and capabilities, Quality of Service (QoS), backhaul limitations, and so on. Such advanced OSDL algorithms may better mitigate unnecessary interference to other small cells and other RATs. For example, they may help Wi-Fi transmissions and thereby make cellular technologies such as LTE better neighbors to Wi-Fi. They may also reduce pilot contamination. They may also improve SCell coverage for small cell base stations configured with multiple SCells.

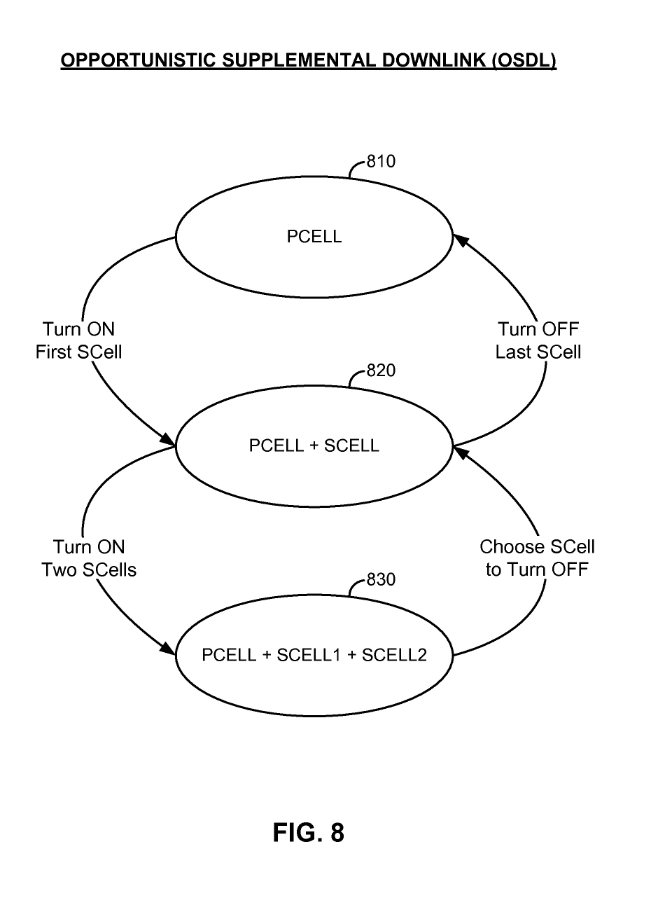

FIG. 8 is a state diagram illustrating OSDL management of SCells operating in conjunction with a given PCell to provide SDL coverage. As shown, system operation may exist in various general states of SCell coverage, including a first state 810 where the PCell operates without any corresponding SCells, a second state 820 where the PCell operates in conjunction with one SCell, and a third state 830 where the PCell operates in conjunction with multiple SCells. Two SCells (SCell1 and SCell2) are shown in FIG. 8 for illustration purposes. As discussed in more detail below, turning on (configuring) or off (de-configuring) different SCell(s) to effect a transition between these states may be performed in a variety of ways.

In general, the SCell configuring/de-configuring decisions may be based on the current utilization of system resources available to the RAT with which the PCell and any SCells are operating (e.g., a cellular RAT such as LTE). When resource utilization is high, it may be advantageous to add an additional SCell to supplement system operation. Conversely, when resource utilization is low, it may advantageous to remove an SCell from system operation to mitigate interference.

Resource utilization may be monitored by reading Resource Block (RB) information or the like from a control channel (e.g., from the first three OFDM symbols of the PDCCH in LTE). The RB information may indicate or be otherwise used to derive measurements reflecting the total number of RBs allocated by the system, the total number of RBs available to the system, and so on. Based on this information, a utilization metric may be calculated (e.g., as the ratio of the total number of RBs allocated to the total number of RBs available).

The measurements may be performed on a periodic (e.g., once every subframe or 1 ms) or event-driven basis as appropriate for a given application. The utilization metric may also be filtered over a sliding time window to balance the need for stable but current usage statistics. As a specific example, the utilization metric may be filtered using a time-dependent averaging function such as the following:

P̅R̅B̅_̅U̅t̅i̅l̅(t+1)=(1−β) P̅R̅B̅_̅U̅t̅i̅l̅(t)+βPRB_Util(t) Eq. 1

where PRB_Util is the utilization metric and β is a filtering coefficient that may be tailored to control the extent to which historical measurement information is retained. It will be appreciated that other time-domain windows and filtering mechanisms (e.g., Infinite impulse response (IIR) filtering) may be used as desired for any given application.

To coordinate with CSAT operation where employed, the filtering may be further configured to ignore or refrain from performing any measurements (e.g., freezing all parameters) during a CSAT OFF period. This may help to ensure that the measurement information is not corrupted by noisy measurements taken at a time when SCell signaling such as pilots (e.g., CRS) and other synchronization signals may be deactivated.

Returning to FIG. 8, the de-configuring of a given SCell may be performed in response to the utilization of at least one (configured) SCell being below a threshold for a time period of interest (e.g., a certain number T of preceding subframes). Such a time period may be used to distinguish sustained utilization from more temporary peak fluctuations. When there is only one SCell in operation (state 820) and that SCell is underutilized, it may be de-configured (effecting a transition to state 810). When there are multiple SCells in operation (state 830), however, further processing may be performed to determine which SCell to de-configure (effecting a transition to state 820). Because the particular SCell that is identified as being underutilized may in fact outperform other SCells in the system in other ways (e.g., spectral efficiency), it may be advantageous to de-configure a different SCell and shift its traffic to the underutilized SCell.

As an example, additional processing may be performed to select, as the target SCell for de-configuring, the SCell among the set of configured SCells that has the lowest spectral efficiency. The identified target SCell may or may not be the same SCell that prompted the need to de-configure SCell operation. The spectral efficiency of a given SCell may be calculated, for example, based on (e.g., as a ratio of) the total number of bits transmitted and the total number of RBs allocated for transmission during a given time period. The total number of RBs allocated may be determined as described above by reading a control channel (e.g., PDCCH in LTE). The corresponding number of bits transmitted may be determined in a similar manner based on control channel information (e.g., from a corresponding Modulation and Coding Scheme (MCS) used for the transmission). As with the utilization metric, the spectral efficiency may be calculated over a sliding time window to balance the need for stable but current spectral efficiency statistics.

Returning again to FIG. 8, the configuring of a given SCell may be performed in response to the utilization of the PCell and/or the utilization of at least one (configured) SCell being above a threshold (e.g., for a certain number T of preceding subframes). This threshold may be the same as the threshold described above for de-configuring an SCell or it may be offset by a given amount (e.g., by a hysteresis offset Δ to prevent undue oscillations in system operation).

When no SCells are currently in operation (state 810) and the PCell is over-utilized, a new SCell may be configured (effecting a transition to state 820). Additional processing may be performed, however, to ensure that at least one (connected mode) user device is within SCell coverage and is capable of SCell operation. Otherwise, adding the new SCell may not provide any offloading benefits. Identification of user devices within SCell coverage may be performed based on user device signal power (e.g., RSRP) measurements on the PCell and adjusting for a band offset between the licensed and unlicensed bands. The band offset may be calculated from the differences in frequency, transmission power, antenna gain, etc., between the PCell and SCell.

The particular SCell to configure may be selected, for example, based on its impact to other RATs in the operating environment. Thus, additional processing may also be performed to select, as the SCell for configuring, an SCell identified by a channel selection algorithm of the type described above, based on each SCell's potential impact on a co-existing RAT (e.g., Wi-Fi) operating in the same unlicensed band.

When at least one SCell is already currently in operation (state 820), similar processing may be performed to determine which SCells should be configured (effecting a transition to state 830). As discussed above, different SCells may outperform each other in different ways and at different times, so it may be advantageous to configure different SCells for multiple-SCell operation than the particular SCell used for single-SCell operation. Moreover, there may be application-specific or other design constraints that require the use of certain combinations of SCells when used in tandem, such as requirements for contiguous SCells within the unlicensed band (which may also reduce adjacent channel leakage effects). Thus, in some situations, two new SCells may be configured and a currently used SCell may be de-configured when a decision is made to add a new SCell. The new SCells to configure may be again selected, for example, based on their impact to other RATs in the operating environment. Again, additional processing may also be performed to select, as the SCells for configuring, two or more SCells identified by a channel selection algorithm of the type described above based on each SCell's potential impact on a co-existing RAT (e.g., Wi-Fi) operating in the same unlicensed band.

In addition to over-the-air resource utilization considerations, OSDL management may additionally be based on backhaul resource utilization conditions. For example, one or more SCells may be de-configured in response to a limited capacity condition being experienced on the backhaul. If the backhaul bandwidth becomes limited due to other devices sharing the backhaul, for example (e.g., TV, gaming, etc., on a user's home Internet connection), additional SCells may experience a traffic bottleneck and be unable to increase overall system throughput in a meaningful way. Accordingly, their operation may cause more interference to other RATs in the operating environment than their true capacity gains warrant. De-configuring one or more SCells in such a scenario may therefore be desirable even when over-the-air capacity is highly loaded.

Further enhancements to the advanced OSDL algorithm described above may be employed as well, such as to meet various design and/or application-specific requirements, as desired. For example, in addition to utilization and spectral efficiency metrics, other metrics based on measurements such as the number of bits being transmitted, the packet error rate, and the packet delay may be monitored and used to optimize SDL operation.

With regard to SCell de-configuring, these additional parameters may allow the OSDL algorithm to not only determine the current utilization of a given SCell but also predict the impact that de-configuring the SCell may have on the traffic load at the PCell and any other remaining SCells. For example, for each configured SCell, estimated utilization metrics for the PCell and any other SCells may be calculated as a function of the number of bits being transmitted by the (respective) cell, the fraction of bits that would be offloaded to the cell from the SCell being de-configured (e.g., based on scheduler load balancing information), and the total number of bits that the cell is capable of transmitting (e.g., based on its spectral efficiency and its total number of RBs available). Under CSAT operation, the number of RB's available at a given SCell will be equal to the total number of RB's multiplied by the CSAT duty cycle (i.e., T_{ON}/T_{CSAT}). These additional utilization metrics may then be checked against a threshold (e.g., for a certain number T of preceding subframes), which may again be offset from the threshold used for the utilization metric of the SCell being de-configured to promote more stable operation.

With regard to SCell configuring, these additional parameters may similarly allow the OSDL algorithm to not only determine the utilization of the PCell and any (configured) SCells but also predict the impact that configuring an SCell may have on the traffic load at the PCell and any other SCells. For example, in addition to current utilization metrics, estimated utilization metrics for PCells and/or other SCells may be calculated based on the number of bits those cells are transmitting to (connected mode) user devices that are within coverage of a potential new SCell and the total number of bits that each cell is capable of transmitting (e.g., based on its spectral efficiency and its total number of RBs available). The estimated utilization metrics may therefore be used to take into account the level of realizable traffic offloading to the potential new SCell. Further, for existing SCells, the estimated utilization metrics may also be used to take into account any effect on the existing coverage provided by the existing SCell if a new SCell were to be added. Coverage may be impacted, for example, by aggregate power restrictions across SCells in the unlicensed band. That is, adding a new SCell may reduce the coverage area of existing SCells and reduce the number of user devices that existing SCells can serve. This may be factored into the corresponding estimated utilization metric, thereby improving SCell coverage for small cell base stations configured with multiple SCells

If the current utilization of the PCell and/or SCells is above a threshold and their estimated utilization after adding a new SCell would bring the utilization to below the threshold (by a given hysteresis offset), it may be advantageous to configure a new SCell. Channel selection may then be invoked to select the best SCell(s) for this purpose, as described above. Again, in assessing the current utilization, a time period of interest may be used to distinguish sustained utilization from more temporary peak fluctuations. Nevertheless, it may be advantageous to use a relatively short time period here for the assessment to avoid fluctuations from so-called link-adaptive streaming, where the traffic for certain video streams, for example, may be adapted by the provider based on link conditions, which may otherwise confound the utilization calculations by making it appear that less traffic is present than would be with increased capacity.

The other parameters may also be used to more accurately capture the amount of traffic load that can be sent on a given Scell. For example, the QoS associated with certain traffic (e.g., as determined by a QoS Class of Identifier (QCI) index) may be used to distinguish traffic that is and is not suitable for SCell offloading, such as Guaranteed Bit Rate (GBR) traffic, which is generally not suitable for offloading from a PCell to an SCell. Other QoS measurements, such as packet delay and packet error rate, may be used in conjunction with a utilization metric to trigger SCell configuration state changes. In addition, the time periods over which the utilization is analyzed and the hysteresis offsets applied to the thresholds above may be determined as a function of QoS.

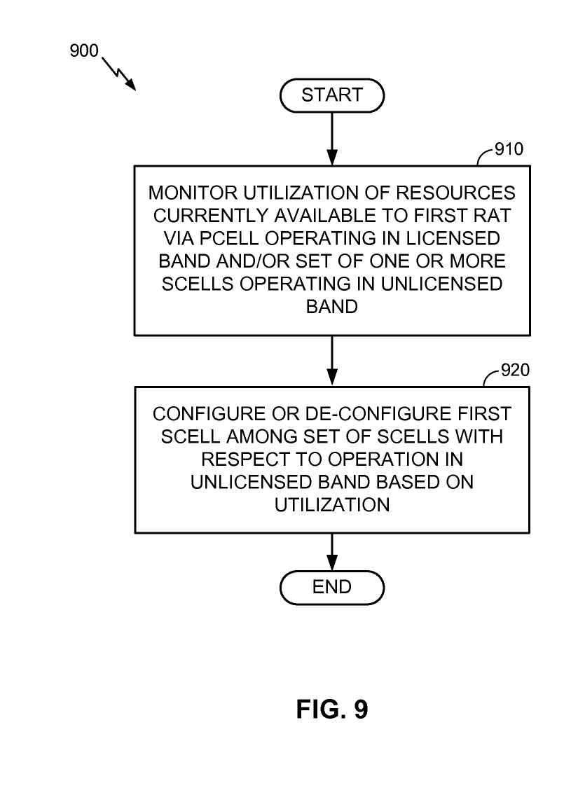

FIG. 9 is a flow diagram illustrating an example method of managing communication in an unlicensed band of frequencies to supplement communication in a licensed band of frequencies. The method 900 may be performed, for example, by a base station (e.g., the small cell base station 110C illustrated in FIG. 1) or other network entity.

As shown, the utilization of resources currently available to a first RAT via a PCell operating in the licensed band and/or a set of one or more SCells operating in the unlicensed band may be monitored (block 910). Based on the utilization, a particular (first) SCell among the set of SCells may be configured or de-configured with respect to operation in the unlicensed band (block 920). It will be appreciated that the “first” label is used merely for identification purposes, and does not imply that the particular SCell is configured or de-configured in any particular order.

As discussed in more detail above, the monitoring (block 910) may be performed in various ways. For example, the monitoring may comprise (e.g., for each of a plurality of detected network elements such as Public Land Mobile Networks (PLMNs)) reading RB information from a control channel (e.g., PDCCH) and calculating a utilization metric based on (e.g., as a ratio of) the total number of RBs allocated and the total number of RBs available as derived from the RB information. The monitoring may further comprise filtering the utilization metric over a sliding or other time-domain window. The filtering may comprise ignoring or refraining from performing any measurements (e.g., freezing all parameters) during a CSAT OFF period. In addition, other parameters such as a packet error rate and/or a packet delay associated with transmissions via the PCell and/or the set of SCells may be monitored, such that the configuring or de-configuring of the first SCell may be further based on the packet error rate and/or the packet delay.

As further discussed in more detail above, the configuring or de-configuring (block 920) may also be performed in various ways. For example, the configuring or de-configuring may comprise de-configuring the first SCell in response to the utilization of at least one of the set of SCells being below a threshold (e.g., for the last T subframes). Here, the first SCell for de-configuring may be selected as the SCell among the set of SCells that has the lowest spectral efficiency (which may or may not be the same SCell that prompted the de-configuring). The spectral efficiency may be calculated by reading a control channel (e.g., PDCCH) to determine the total number of RBs allocated for transmission during a given time period and a corresponding MCS used for transmission, determining, based on the MCS, a corresponding number of bits transmitted, and calculating the spectral efficiency based on (e.g., as a ratio of) the total number of bits transmitted and the total number of RBs allocated (over a given time period duration). The spectral efficiency may be calculated over a sliding time window. In some designs, the method may further comprise estimating utilization of resources available to the first RAT via the PCell and/or the set of SCells if the first SCell is de-configured, such that the de-configuring of the first SCell may be further in response to the estimated utilization being below a threshold.

As another example, the configuring or de-configuring may comprise configuring the first SCell in response to the utilization of the PCell and/or the utilization of at least one of the set of SCells being above a threshold (e.g., for the last T subframes). Here, configuring the first SCell may comprise determining if there are any UEs within SCell coverage and configuring the first SCell in response to the utilization of the PCell being above the threshold and at least one UE being within SCell coverage. The first SCell for configuring may be selected as the SCell identified by a channel selection algorithm based on its impact on a second RAT operating in the unlicensed band. The configuring of the first SCell may comprise configuring the first SCell, configuring a second SCell among the set of SCells, and de-configuring a third SCell among the set of SCells. Here, the first and second SCells for configuring may be selected as the two SCells identified by a channel selection algorithm as performing better than the third SCell with respect to their impact on a second RAT operating in the unlicensed band. In some designs, the method may further comprise estimating utilization of resources available to the first RAT via the PCell and/or the set of SCells if the first SCell is configured, such that the configuring of the first SCell may be further in response to the estimated utilization being below a threshold.

In addition to monitoring over-the-air resource utilization, backhaul resource utilization associated with a shared backhaul connection may be monitored as well. Based on the backhaul resource utilization, at least one SCell among the set of SCells may be de-configured with respect to operation in the unlicensed band (e.g., if the backhaul resource utilization is high, indicating a backhaul limited condition).

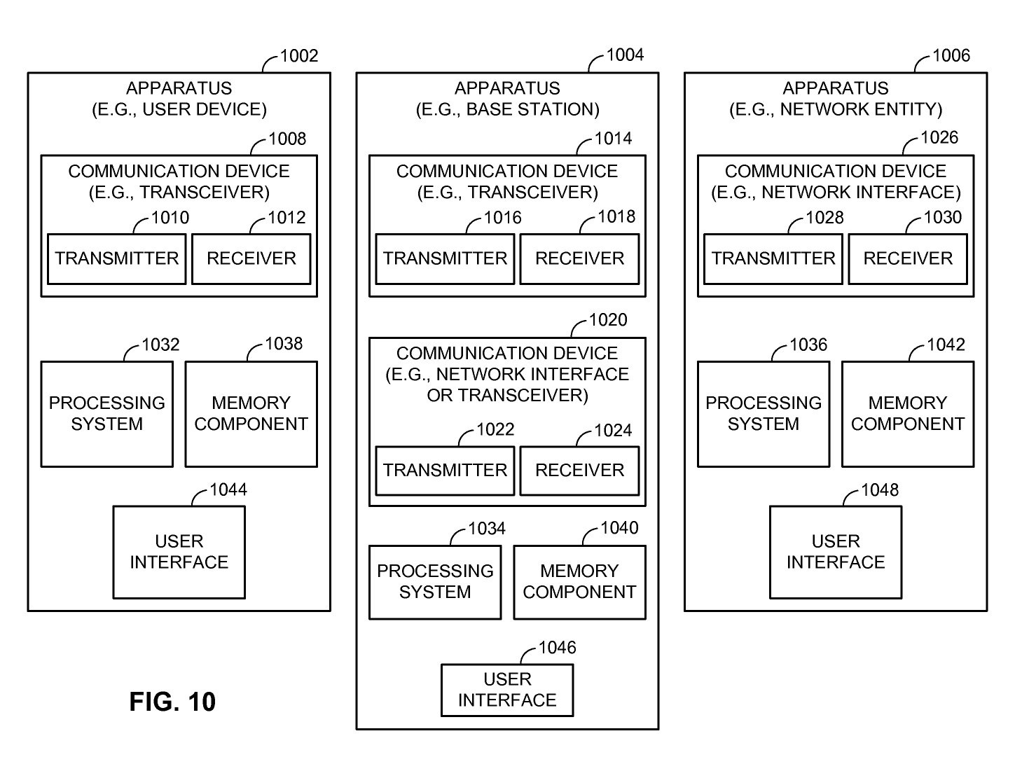

FIG. 10 illustrates several sample components (represented by corresponding blocks) that may be incorporated into an apparatus 1002, an apparatus 1004, and an apparatus 1006 (corresponding to, for example, a user device, a base station, and a network entity, respectively) to support the OSDL operations as taught herein. It will be appreciated that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 1002 and the apparatus 1004 each include at least one wireless communication device (represented by the communication devices 1008 and 1014 (and the communication device 1020 if the apparatus 1004 is a relay)) for communicating with other nodes via at least one designated RAT. Each communication device 1008 includes at least one transmitter (represented by the transmitter 1010) for transmitting and encoding signals (e.g., messages, indications, information, and so on) and at least one receiver (represented by the receiver 1012) for receiving and decoding signals (e.g., messages, indications, information, pilots, and so on). Similarly, each communication device 1014 includes at least one transmitter (represented by the transmitter 1016) for transmitting signals (e.g., messages, indications, information, pilots, and so on) and at least one receiver (represented by the receiver 1018) for receiving signals (e.g., messages, indications, information, and so on). If the apparatus 1004 is a relay station, each communication device 1020 may include at least one transmitter (represented by the transmitter 1022) for transmitting signals (e.g., messages, indications, information, pilots, and so on) and at least one receiver (represented by the receiver 1024) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. A wireless communication device (e.g., one of multiple wireless communication devices) of the apparatus 1004 may also comprise a Network Listen Module (NLM) or the like for performing various measurements.

The apparatus 1006 (and the apparatus 1004 if it is not a relay station) includes at least one communication device (represented by the communication device 1026 and, optionally, 1020) for communicating with other nodes. For example, the communication device 1026 may comprise a network interface that is configured to communicate with one or more network entities via a wire-based or wireless backhaul. In some aspects, the communication device 1026 may be implemented as a transceiver configured to support wire-based or wireless signal communication. This communication may involve, for example, sending and receiving: messages, parameters, or other types of information. Accordingly, in the example of FIG. 10, the communication device 1026 is shown as comprising a transmitter 1028 and a receiver 1030. Similarly, if the apparatus 1004 is not a relay station, the communication device 1020 may comprise a network interface that is configured to communicate with one or more network entities via a wire-based or wireless backhaul. As with the communication device 1026, the communication device 1020 is shown as comprising a transmitter 1022 and a receiver 1024.

The apparatuses 1002, 1004, and 1006 also include other components that may be used in conjunction with the OSDL operations as taught herein. The apparatus 1002 includes a processing system 1032 for providing functionality relating to, for example, user device operations to support OSDL as taught herein and for providing other processing functionality. The apparatus 1004 includes a processing system 1034 for providing functionality relating to, for example, base station operations to support OSDL as taught herein and for providing other processing functionality. The apparatus 1006 includes a processing system 1036 for providing functionality relating to, for example, network operations to support OSDL as taught herein and for providing other processing functionality. The apparatuses 1002, 1004, and 1006 include memory components 1038, 1040, and 1042 (e.g., each including a memory device), respectively, for maintaining information (e.g., information indicative of reserved resources, thresholds, parameters, and so on). In addition, the apparatuses 1002, 1004, and 1006 include user interface devices 1044, 1046, and 1048, respectively, for providing indications (e.g., audible and/or visual indications) to a user and/or for receiving user input (e.g., upon user actuation of a sensing device such a keypad, a touch screen, a microphone, and so on).

For convenience, the apparatuses 1002, 1004, and/or 1006 are shown in FIG. 10 as including various components that may be configured according to the various examples described herein. It will be appreciated, however, that the illustrated blocks may have different functionality in different designs.

The components of FIG. 10 may be implemented in various ways. In some implementations, the components of FIG. 10 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1008, 1032, 1038, and 1044 may be implemented by processor and memory component(s) of the apparatus 1002 (e.g., by execution of appropriate code and/or by appropriate configuration of processor components). Similarly, some or all of the functionality represented by blocks 1014, 1020, 1034, 1040, and 1046 may be implemented by processor and memory component(s) of the apparatus 1004 (e.g., by execution of appropriate code and/or by appropriate configuration of processor components). Also, some or all of the functionality represented by blocks 1026, 1036, 1042, and 1048 may be implemented by processor and memory component(s) of the apparatus 1006 (e.g., by execution of appropriate code and/or by appropriate configuration of processor components).

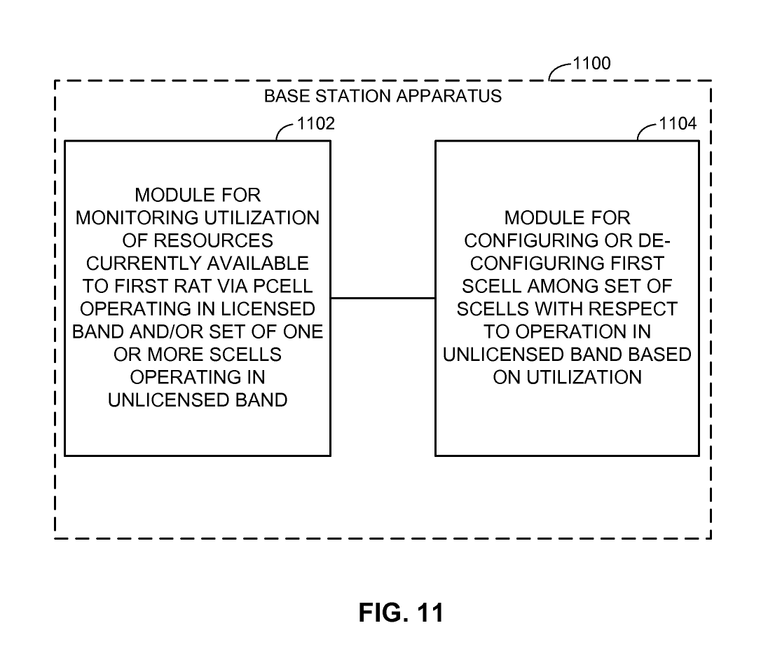

FIG. 11 illustrates an example base station apparatus 1100 represented as a series of interrelated functional modules. A module for monitoring 1102 may correspond at least in some aspects to, for example, a communication system in conjunction with a processing system as discussed herein. A module for configuring or de-configuring 1104 may correspond at least in some aspects to, for example, a processing system as discussed herein.

The functionality of the modules of FIG. 11 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 11, as well as other components and functions described herein, may be implemented using any suitable means. Such means also may be implemented, at least in part, using corresponding structure as taught herein. For example, the components described above in conjunction with the “module for” components of FIG. 11 also may correspond to similarly designated “means for” functionality. Thus, in some aspects one or more of such means may be implemented using one or more of processor components, integrated circuits, or other suitable structure as taught herein.

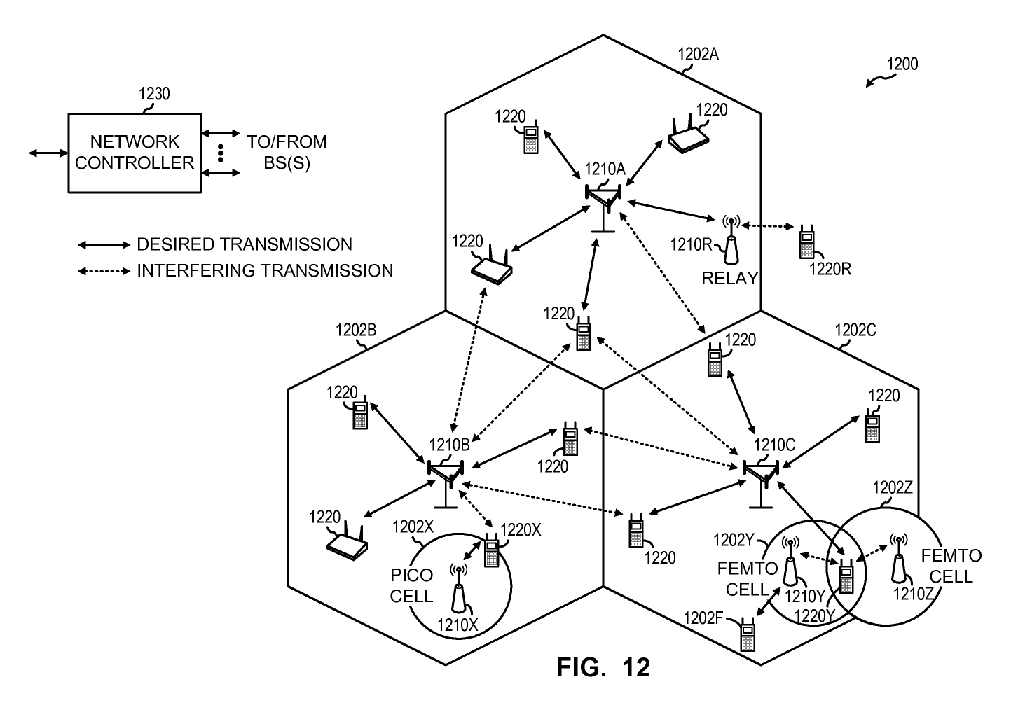

FIG. 12 illustrates an example communication system environment in which the OSDL teachings and structures herein may be may be incorporated. The wireless communication system 1200, which will be described at least in part as an LTE network for illustration purposes, includes a number of eNBs 1210 and other network entities. Each of the eNBs 1210 provides communication coverage for a particular geographic area, such as macro cell or small cell coverage areas.

In the illustrated example, the eNBs 1210A, 1210B, and 1210C are macro cell eNBs for the macro cells 1202A, 1202B, and 1202C, respectively. The macro cells 1202A, 1202B, and 1202C may cover a relatively large geographic area (e.g., several kilometers in radius) and may allow unrestricted access by UEs with service subscription. The eNB 1210X is a particular small cell eNB referred to as a pico cell eNB for the pico cell 1202X. The pico cell 1202X may cover a relatively small geographic area and may allow unrestricted access by UEs with service subscription. The eNBs 1210Y and 1210Z are particular small cells referred to as femto cell eNBs for the femto cells 1202Y and 1202Z, respectively. The femto cells 1202Y and 1202Z may cover a relatively small geographic area (e.g., a home) and may allow unrestricted access by UEs (e.g., when operated in an open access mode) or restricted access by UEs having association with the femto cell (e.g., UEs in a Closed Subscriber Group (CSG), UEs for users in the home, etc.), as discussed in more detail below.

The wireless network 1200 also includes a relay station 1210R. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs (e.g., a mobile hotspot). In the example shown in FIG. 12, the relay station 1210R communicates with the eNB 1210A and a UE 1220R in order to facilitate communication between the eNB 1210A and the UE 1220R. A relay station may also be referred to as a relay eNB, a relay, etc.

The wireless network 1200 is a heterogeneous network in that it includes eNBs of different types, including macro eNBs, pico eNBs, femto eNBs, relays, etc. As discussed in more detail above, these different types of eNBs may have different transmit power levels, different coverage areas, and different impacts on interference in the wireless network 1200. For example, macro eNBs may have a relatively high transmit power level whereas pico eNBs, femto eNBs, and relays may have a lower transmit power level (e.g., by a relative margin, such as a 10 dBm difference or more).

Returning to FIG. 12, the wireless network 1200 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. Unless otherwise noted, the techniques described herein may be used for both synchronous and asynchronous operation.

A network controller 1230 may couple to a set of eNBs and provide coordination and control for these eNBs. The network controller 1230 may communicate with the eNBs 1210 via a backhaul. The eNBs 1210 may also communicate with one another, e.g., directly or indirectly via a wireless or wireline backhaul.

As shown, the UEs 1220 may be dispersed throughout the wireless network 1200, and each UE may be stationary or mobile, corresponding to, for example, a cellular phone, a personal digital assistant (PDA), a wireless modem, a wireless communication device, a handheld device, a laptop computer, a cordless phone, a wireless local loop (WLL) station, or other mobile entities. In FIG. 12, a solid line with double arrows indicates desired transmissions between a UE and a serving eNB, which is an eNB designated to serve the UE on the downlink and/or uplink. A dashed line with double arrows indicates potentially interfering transmissions between a UE and an eNB. For example, UE 1220Y may be in proximity to femto eNBs 1210Y, 1210Z. Uplink transmissions from UE 1220Y may interfere with femto eNBs 1210Y, 1210Z. Uplink transmissions from UE 1220Y may jam femto eNBs 1210Y, 1210Z and degrade the quality of reception of other uplink signals to femto eNBs 1210Y, 1210Z.

Small cell eNBs such as the pico cell eNB 1210× and femto eNBs 1210Y, 1210Z may be configured to support different types of access modes. For example, in an open access mode, a small cell eNB may allow any UE to obtain any type of service via the small cell. In a restricted (or closed) access mode, a small cell may only allow authorized UEs to obtain service via the small cell. For example, a small cell eNB may only allow UEs (e.g., so called home UEs) belonging to a certain subscriber group (e.g., a CSG) to obtain service via the small cell. In a hybrid access mode, alien UEs (e.g., non-home UEs, non-CSG UEs) may be given limited access to the small cell. For example, a macro UE that does not belong to a small cell's CSG may be allowed to access the small cell only if sufficient resources are available for all home UEs currently being served by the small cell.

By way of example, femto eNB 1210Y may be an open-access femto eNB with no restricted associations to UEs. The femto eNB 1210Z may be a higher transmission power eNB initially deployed to provide coverage to an area. Femto eNB 1210Z may be deployed to cover a large service area. Meanwhile, femto eNB 1210Y may be a lower transmission power eNB deployed later than femto eNB 1210Z to provide coverage for a hotspot area (e.g., a sports arena or stadium) for loading traffic from either or both eNB 1210C, eNB 1210Z.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for managing communication in an unlicensed band of frequencies to supplement communication in a licensed band of frequencies.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of managing communication in an unlicensed band of radio frequencies to supplement communication in a licensed band of radio frequencies, comprising:
monitoring utilization of resources currently available to a first Radio Access Technology (RAT) via at least one of a Primary Cell (PCell) operating in the licensed band, a set of one or more Secondary Cells (SCells) operating in the unlicensed band, or a combination thereof; and
configuring or de-configuring a first SCell among the set of SCells with respect to operation in the unlicensed band based on the utilization.

2. The method of claim 1, wherein the monitoring comprises:
reading Resource Block (RB) information from a control channel; and
calculating a utilization metric based on the total number of RBs allocated and the total number of RBs available as derived from the RB information.

3. The method of claim 2, further comprising detecting a plurality of different network elements operating on a given channel, wherein the utilization metric is calculated for each of the detected network elements.

4. The method of claim 2, wherein the monitoring further comprises filtering the utilization metric over a sliding or other time-domain window.

5. The method of claim 4, wherein the filtering comprises ignoring or refraining from performing one or more measurements during a Carrier Sense Adaptive Transmission (CSAT) OFF period.

6. The method of claim 1, further comprising monitoring a packet error rate or a packet delay associated with transmissions via the PCell or the set of SCells, wherein configuring or de-configuring the first SCell is further based on the packet error rate or the packet delay.

7. The method of claim 1, wherein the configuring or de-configuring comprises de-configuring the first SCell in response to the utilization of at least one of the set of SCells being below a threshold.

8. The method of claim 7, further comprising selecting, as the first SCell for de-configuring, the SCell among the set of SCells that has the lowest spectral efficiency.

9. The method of claim 8, further comprising:
reading a control channel to determine the total number of Resource Blocks (RBs) allocated for transmission during a given time period and a corresponding Modulation and Coding Scheme (MCS) used for transmission;
determining, based on the MCS, a corresponding number of bits transmitted; and
calculating the spectral efficiency based on the total number of bits transmitted, the total number of RBs allocated, and a duration of the given time period.

10. The method of claim 9, wherein the spectral efficiency is calculated over a sliding or other time-domain window.

11. The method of claim 7, further comprising estimating utilization of resources available to the first RAT via the PCell and the set of SCells if the first SCell is de-configured, wherein de-configuring the first SCell is further in response to the estimated utilization being below a threshold.

12. The method of claim 1, wherein the configuring or de-configuring comprises configuring the first SCell in response to the utilization of the PCell or the utilization of at least one of the set of SCells being above a threshold.

13. The method of claim 12, wherein the configuring of the first SCell comprises:
determining if there is at least one user device within SCell coverage; and
configuring the first SCell in response to the utilization of the PCell being above the threshold and the at least one user device being within SCell coverage.

14. The method of claim 13, further comprising selecting, as the first SCell for configuring, an SCell identified by a channel selection algorithm based on its impact on a second RAT operating in the unlicensed band.

15. The method of claim 12, wherein the configuring of the first SCell comprises configuring the first SCell, configuring a second SCell among the set of SCells, and de-configuring a third SCell among the set of SCells.

17. The method of claim 15, further comprising selecting, as the first and second SCells for configuring, two SCells identified by a channel selection algorithm as performing better than the third SCell with respect to their impact on a second RAT operating in the unlicensed band.

17. The method of claim 12, further comprising estimating utilization of resources available to the first RAT via the PCell and the set of SCells if the first SCell is configured, wherein configuring the first SCell is further in response to the estimated utilization being below a threshold.

18. The method of claim 1, further comprising:
monitoring backhaul resource utilization associated with a shared backhaul connection; and
de-configuring at least one SCell among the set of SCells with respect to operation in the unlicensed band based on the backhaul resource utilization.

19. An apparatus for managing communication in an unlicensed band of radio frequencies to supplement communication in a licensed band of radio frequencies, comprising:
a processor configured to:
monitor utilization of resources currently available to a first Radio Access Technology (RAT) via at least one of a Primary Cell (PCell) operating in the licensed band, a set of one or more Secondary Cells (SCells) operating in the unlicensed band, or a combination thereof, and
configure or de-configuring a first SCell among the set of SCells with respect to operation in the unlicensed band based on the utilization; and
memory coupled to the processor for storing related data and instructions.

20. The apparatus of claim 19, wherein the configuring or de-configuring comprises de-configuring the first SCell in response to the utilization of at least one of the set of SCells being below a threshold.

21. The apparatus of claim 20, wherein the processor is further configured to select, as the first SCell for de-configuring, the SCell among the set of SCells that has the lowest spectral efficiency.

22. The apparatus of claim 20, wherein the processor is further configured to estimate utilization of resources available to the first RAT via the PCell and the set of SCells if the first SCell is de-configured, and wherein de-configuring the first SCell is further in response to the estimated utilization being below a threshold.

23. The apparatus of claim 19, wherein the configuring or de-configuring comprises configuring the first SCell in response to the utilization of the PCell or the utilization of at least one of the set of SCells being above a threshold.

24. The apparatus of claim 23, wherein the configuring of the first SCell comprises:
determining if there is at least one user device within SCell coverage; and
configuring the first SCell in response to the utilization of the PCell being above the threshold and the at least one user device being within SCell coverage.

25. The apparatus of claim 24, wherein the processor is further configured to select, as the first SCell for configuring, an SCell identified by a channel selection algorithm based on its impact on a second RAT operating in the unlicensed band.

26. The apparatus of claim 23, wherein the configuring of the first SCell comprises configuring the first SCell, configuring a second SCell among the set of SCells, and de-configuring a third SCell among the set of SCells.

27. The apparatus of claim 26, wherein the processor is further configured to select, as the first and second SCells for configuring, two SCells identified by a channel selection algorithm as performing better than the third SCell with respect to their impact on a second RAT operating in the unlicensed band.

28. The apparatus of claim 19, wherein the processor is further configured to:
monitor backhaul resource utilization associated with a shared backhaul connection; and
de-configure at least one SCell among the set of SCells with respect to operation in the unlicensed band based on the backhaul resource utilization.

29. An apparatus for managing communication in an unlicensed band of radio frequencies to supplement communication in a licensed band of radio frequencies, comprising:
means for monitoring utilization of resources currently available to a first Radio Access Technology (RAT) via at least one of a Primary Cell (PCell) operating in the licensed band, a set of one or more Secondary Cells (SCells) operating in the unlicensed band, or a combination thereof; and
means for configuring or de-configuring a first SCell among the set of SCells with respect to operation in the unlicensed band based on the utilization.

30. A non-transitory computer-readable medium comprising instructions, which, when executed by a processor, cause the processor to perform operations for managing communication in an unlicensed band of radio frequencies to supplement communication in a licensed band of radio frequencies, the non-transitory computer-readable medium comprising:
instructions for monitoring utilization of resources currently available to a first Radio Access Technology (RAT) via at least one of a Primary Cell (PCell) operating in the licensed band, a set of one or more Secondary Cells (SCells) operating in the unlicensed band, or a combination thereof; and
instructions for configuring or de-configuring a first SCell among the set of SCells with respect to operation in the unlicensed band based on the utilization.
